(19) United States
(12) Patent Application Publication
(10) Pub. No.: US 2007/0281748 A1
(43) Pub. Date: Dec. 6, 2007

(54) Method & apparatus for unlocking a mobile phone keypad

(75) Inventor: Christopher J. Piekarski, Boulder, CO (US)

Correspondence Address: Robert C Schuler, 45 Groton Road, Shirley, MA, 01464, US

(73) Assignee: SpectraLink Corp.

(21) Appl. No.: 11/444,025

(22) Filed: May 31, 2006

(51) Int. Cl. H04M 1/00

(52) U.S. Cl. 455/565

(57) ABSTRACT

A mobile communications device includes a keypad, microphone, speaker and a communications application. The communications devices keypad can be changed from a disabled state, or a state in which depressing keys on the keypad have no effect on the functionality of the communications device, to an enabled state. A user can change the state of the communications device keypad to be enabled, from a disabled state, by providing the communications device with input which results in the communications device displaying a prompt for the user to act on in order to enable the keypad.

### FIELD OF THE INVENTION

This invention relates generally to the field electronic devices that have keys on a keyboard or keypad that a user depresses to operate the device and more specifically to the area of keypad locking and unlocking mechanisms.

### BACKGROUND OF THE INVENTION

With the advent of portable communications devices that can be conveniently carried around in a users pocket, on a belt clip, or in a purse, it has become necessary to disable the keys on the keypads of such devices so that they are not inadvertently pressed which could result in the device being turned on or if they are turned on so that certain function keys used to initiate a call, for instance, are not inadvertently depressed. Such portable devices employ batteries for power with only limited life and so these devices typically employ methods to automatically turn off or go to a low power or standby state when not in use in order to preserve power. As depressing a key on the device typically could transition the device from the low power state to a high power state, it is desirable to disable the keypads of such devices when not in use.

A number of prior art methods have been employed to disable and subsequently enable the keypads of these portable communications devices. One such method is described in U.S. Pat. No. 6,801,765. This patent describes an anti-fraud protection method whereby a phone that has been locked can be unlocked provided the user knows a secret code which is entered using the keypad. As described with reference to FIG. 3a. The user is prompted by the phone in a voice message to enter the secret code after waiting some predetermined period of time. If the user enters the secret code correctly, the phone is activated and can then be used to make calls.

Another U.S. Pat. No. 5,065,155 discloses in the abstract a method for releasing an inhibited keyboard state by detecting that a plurality of keys of the keyboard were depressed in a predetermined order. Another U.S. Pat. No. 5,864,765 describes a method for activating a keypad that has been previously inactivated by depressing one key that has been kept active. The one active key could be any key that has been selected to be active. Yet another U.S. Pat. No. 6,768,428 describes a method for exiting from a keyboard disabled state by depressing a specific, simultaneous combination of keys.

Yet another method for unlocking a keyboard is embodied in a mobile phone, sold under the NetLink name, manufactured by the SpectraLink Corporation. Once the keyboard is locked, the phone continuously displays on its screen an indication as to which key the user has to depress in order to initiate the keypad unlocking function. As the result of depressing the specified key, the screen displays a number of sequential prompts for the user to follow to unlock the keypad. While it may not be to onerous for the user to remember which key to press in order to display the unlock prompt, maintaining a continuous display of which key to depress in order to initiate the unlocking process is a drain on the phones battery and the process of unlocking the phone is unnecessarily cumbersome.

All of the above methods for enabling a keypad that have previously been disabled suffer from the same shortcoming; namely, it is incumbent upon the user to remember which keys or combination of keys need to be depressed in order to enable the keypad functionality or the process that the user has to follow in order to enable the keypad is unnecessarily cumbersome.

### SUMMARY OF THE INVENTION

Therefore, it is our intention to provide a novel solution to the problem of the user having to remember how to enable a keypad that has been previously disabled by providing a visual indication on the keypad for the user to follow when they would like to enable the keypad functionality. The visual indication can lead the user to depress one key or a plurality of keys in a particular sequence. The visual indication can lead the user to depress a plurality of keys at the same time or the visual indication could lead the user to depress one or more keys for a particular period of time.

In one embodiment of our invention, the visual indication is provided on the keypad by backlighting the key or keys that the user should depress in order to enable the keypad functionality.

In another aspect of our invention, the visual indication is provided on the keypad by sequentially backlighting two or more keys that should be depressed in the order that they should be depressed.

In another embodiment of our invention, a user provides input to the device which results in the device providing a prompt that is indicative of one or more actions to take in order to enable the keypad,

In yet another aspect of our invention, depressing any key on the keypad activates a prompt that indicates to the user how to proceed to enable the keypad of the mobile communications device.

### BRIEF DESCRIPTION OF THE DRAWINGS

FIG. 1 is an illustration of a representative mobile phone that incorporates the invention.

FIG. 2 is a functional block diagram of a mobile phone showing the elements necessary to implement the invention.

FIG. 3 is a logical flow diagram showing the preferred embodiment of the invention.

FIG. 4 is a logical flow diagram showing an alternative embodiment of the invention.

### DETAILED DESCRIPTION OF THE INVENTION

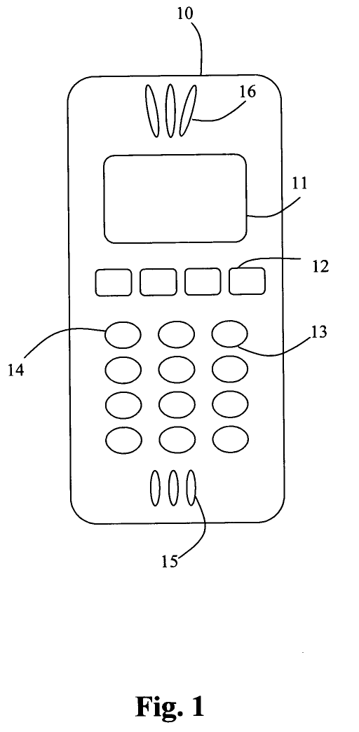

We will start by briefly describing the process a user follows to place a mobile phone keypad in the locked or disabled mode. After completing a call, and not contemplating using the mobile phone for some period of time, it is desirable for the phone to transition to a low powered standby mode in order to prolong battery life. During the time the mobile phone is in this low power mode, it is desirable to be able to disable the keypad function so that if any keys are inadvertently depressed the mobile phone will not transition out of the standby mode to a higher powered mode. Referring to FIG. 1, in order to disable the keypad on the mobile phone, the user depresses the FCN key 12 which results in the display 11 prompting the user to depress one or more keys in some sequential order to disable the keypad. At the point that the keypad has been disabled, any inadvertent depression of any one of the keys will not result in the initialization of any mobile phone functionality. In the event that the phone senses that there is an incoming call, it temporarily transitions to a higher power in call mode to process the received call information and at the end of the call automatically returns to the lower power standby mode and the keypad is automatically disabled. This is an automatic process that does not require any input from the user.

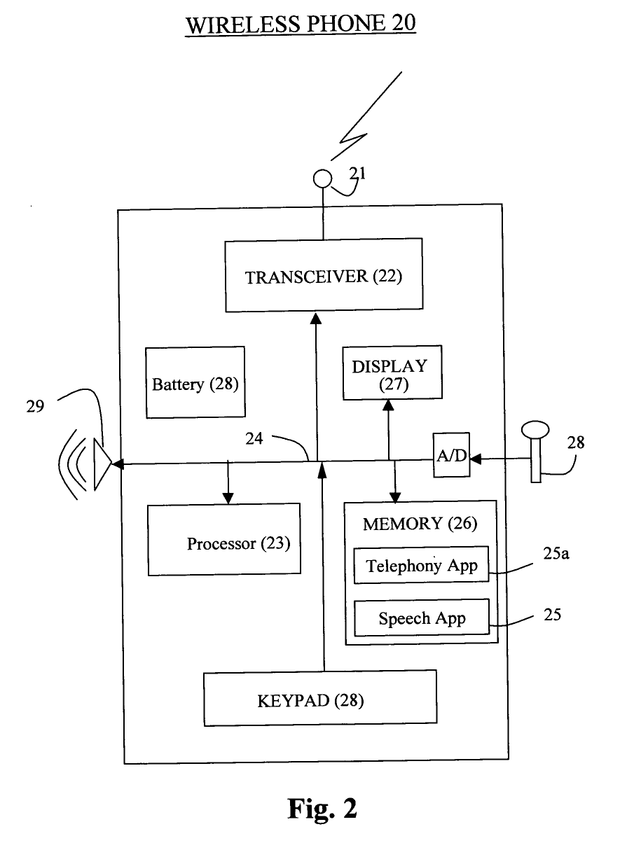

At the point that the user wishes to use the mobile phone to make a call and if the keypad is disabled, it is necessary to enable the keypad. FIG. 2 is a block diagram that illustrates the functional blocks necessary to implement the keypad enabling process of my invention in a mobile phone 20. The mobile phone is comprised of an antenna 21 that operates to propagate wireless voice signals and is the initial reception point for incoming wireless voice signals. The antenna is connected to transceiver 22 which operates to demodulate the signals containing voice information received from the antenna. The transceiver is connected over a parallel bus 22 to a processor 23 which includes an operating system in the form of firmware that operates in cooperation with a telephony application 25 stored in memory 24 to manage the functionality of the phone, including the processes used to disable and enable the mobile phone's keypad 26. The mobile phone 20 also has an LCD or some other type of display 27 that is employed to provide visual information to the user. This visual information could include such things as the current operating mode of the mobile phone or whether the keypad is enabled or disabled for instance or prompts to guide the user through the keypad disabling or enabling process. The mobile phone also has a microphone 28 that the user speaks into and which converts sound waves to electrical analog waves that are converted at the A/D converter 28a into digital waves before being sent to the Speech application 25. The audio to speech conversion process I have briefly described above is a very standard design and well within the capability of an audio engineer to design and so will not be described here in detail. The phone also has a speaker 29 that generates different audible sounds which provide the user with some audio feedback regarding the operation of the mobile phone

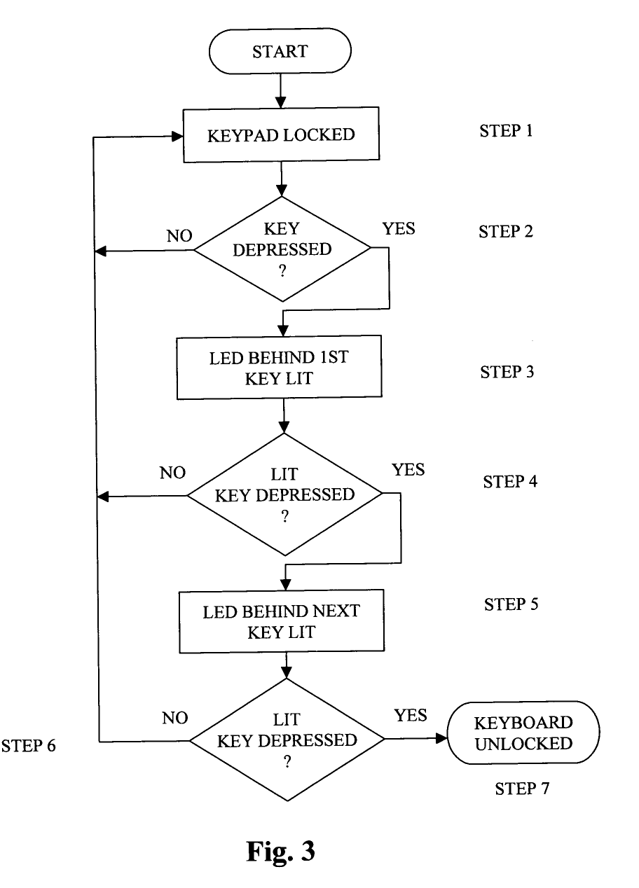

I will now describe the preferred embodiment of the invention with respect to FIG. 3. In step 1, the keypad of the mobile phone is in the disabled state and the phone can be in the standby mode of operation with no backlighting of the keypad keys. At the point that the user wishes to use the mobile phone, in step 2 they would depress any one of the keys on the keypad, which could be key 13 for instance, and the process would proceed to step 3 where the telephony application 25 of FIG. 1 would cause a single, first key to be back lighted, which key could be key 14 for instance. The user would know by the backlighting, that this back lighted key should be depressed in order to proceed with the keypad enabling process. More specifically, depression of a key sends a signal, which is similar to an interrupt, to the processor 23 of FIG. 2. When receiving such a signal while in the keypad lock mode, the processor interprets this as a command to initiate the keypad unlocking sequence. The processor then accesses the application 25 in memory 24 at an address which contains the keypad unlocking routine, fetches and operates on the first keypad unlocking instruction, which in this case is an instruction to light an LED behind a particular key, key 14 in this case, on the keypad, the result of which causes the LED to light behind the first key that the user should depress in order to proceed with the sequence. Assuming, in step 4 of FIG. 3, that the user depresses the single, first key that is back lighted, the telephony application then enables a different second or next key, key 13 for instance, to be back lighted following a similar process as described above in step 3. Assuming that the user depresses this next key, the keypad becomes enabled and the user would be able to start a call or initiate some other mobile phone functionality using the keypad. If, on the other hand, in step 2, 4, or 6 the user does not depress a key, the keypad remains in the disabled state as indicated in FIG. 3. The user can be prompted to depress more than two keys, but for the purpose of this description we will limit the number of keys that should be depressed to enable the keypad to two.

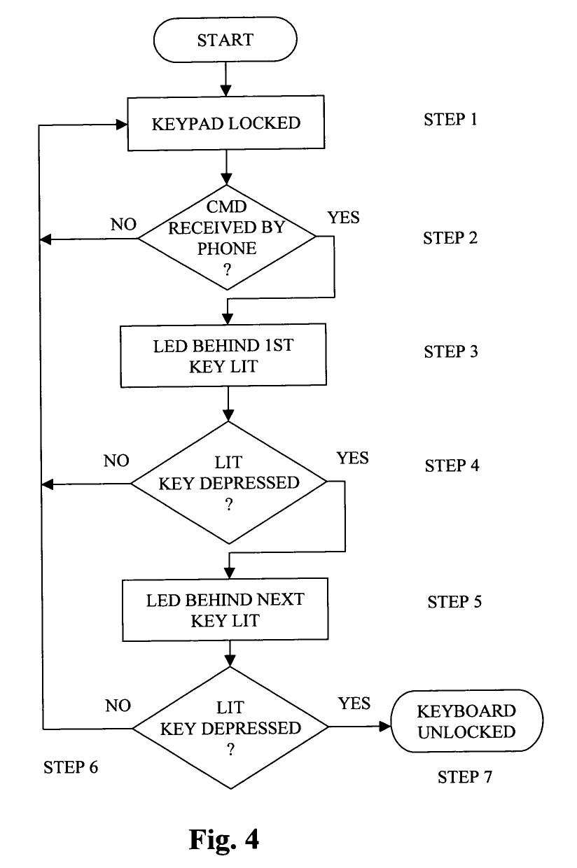

While our preferred embodiment describes a process whereby the user depresses a key on the keypad in order to initiate the keypad unlocking sequence, the user can take other action what will initiate this sequence. This other action could be a voice command, for instance. FIG. 4 is a logical flow diagram that describes a keyboard unlocking sequence that is initiated by the user uttering a voice command. In step 1, the keypad is in the locked mode of operation and the user cannot enable any of the phones functionality by simply depressing a key. In step 2, the user utters a verbal command, such as “unlock keypad”, into the phones microphone 15 of FIG. 2 which is processed by an A/D converter 28a before being analyzed by a speech recognition application 25 stored in memory 26 which converts the recognized verbal command into an instruction sent to the DSP 23 to start the keypad enablement sequence. Alternatively, the verbal command above could result in the mobile phone generating a speech prompt over speaker 29, such as “depress the backlit key 14, for instance, on the keypad”. In step 3, an LED behind the first key which should be depressed is lit and in step 4 the user depresses this first backlit key. The keypad unlocking sequence may only require that a single backlit key be depressed to enable the keypad or the keypad unlocking sequence may require that a plurality of backlit keys be depressed depending upon, among others things, the speed with which it is desirable to unlock the keypad. Continuing with step 5 of FIG. 4, assuming that the first backlit key 14 is depressed, which causes a signal to be sent to the processor 23 and the processor accessing the keypad unlocking routine in telephony application 25 as previously described, the next key 13, for instance, is backlit and in step 5, the user depresses this next backlit key 13 whereupon the keypad transitions to the enabled mode of operation and is available to the user to, among other things, start a call.

Alternatively, the command issued by the user to initiate the keypad unlocking sequence could have the result of causing the mobile phone to display a text prompt for the user to depress the backlit key. This would enable users, not familiar with the operation of the mobile phone keypad unlocking sequence, to unlock the keypad without assuming that they should depress a backlit key.

I claim:

1. A method for enabling a previously disabled keypad on a mobile communications device comprising the steps of:
depressing any key on the keypad in order to activate a prompt that is indicative of the next key to depress;
depressing the key on the keypad as indicated by the prompt; and
the keypad becoming enabled as the result of entering into the mobile communications device the prompted information.

2. The mobile communications device of claim 1 is a mobile phone.

3. The prompt of claim 1 is a backlit key on the keypad.

4. The prompt of claim 1 is a text message instructing the user to depress a backlit key.

5. The prompt of claim 1 is an audio message indicating which key on the keypad to depress.

6. A method for enabling a previously disabled keypad on a mobile communications device comprising the steps of:
a mobile communications device user providing the mobile communications device with input to activate a prompt that is indicative of at least one action to take in order to enable the keypad;
the mobile communications device user performing the at least one action as indicated by the prompt; and
the keypad becoming enabled as the result of the user performing the at least one prompted action.

7. The mobile communications device of claim 6 is a mobile phone.

8. The user provided input of claim 6 is a voice command uttered by the mobile phone user.

9. The user provided input of claim 6 is the depression of any key on the keypad.

10. The prompt of claim 6 is an audio indication instructing the user to depress at least one particular key on the keypad.

11. The prompt of claim 6 is a text message instructing the mobile phone user to utter at least one particular voice command.

12. The prompt of claim 6 is a backlit key on the keypad.

13. A method for enabling a previously disabled keypad on a mobile communications device comprising the steps of:
a mobile communications device user providing the mobile communications device with input to initiate a keypad enablement sequence;
as the result of the user providing input to the mobile communications device, at least a first visual prompt is displayed on the mobile communications device that serves as an indication for performing the next step of the keypad enablement sequence;
the user acting on the indication provided by the at least first visual prompt to perform the next step of the keypad enablement sequence; and
the keypad becoming enabled as the result of the action taken by the user.

14. The mobile communications device of claim 13 is a mobile phone.

15. The input provided by the user to the mobile phone of claim 13 is one of depressing any key on the keypad and uttering a voice command.

16. The at least first visual prompt displayed on the mobile phone of claim 13 is one of a text message and a backlit key on the keypad.

17. The next step in the keypad enablement sequence of claim 13 is one of the user uttering a verbal command and the user depressing a particular key on the keypad.
